(19) United States
(12) Patent Application Publication
(10) Pub. No.: US 2011/0197406 A1
(43) Pub. Date: Aug. 18, 2011

(54) SECURING ARRANGEMENT FOR SECURING A DIVING CYLINDER TO A BUOYANCY CONTROL DEVICE

(76) Inventor: Rhys James Couzyn, Kwa Zulu Natal (ZA)

(21) Appl. No.: 12/673,199

(22) PCT Filed: Aug. 4, 2008
(86) PCT No.: PCT/IB08/53108

§ 371 Date: Apr. 13, 2010

(30) Foreign Application Priority Data
Aug. 10, 2007 (ZA) 2007/06949

(51) Int. Cl. B25B 25/00; A44B 11/25

(52) U.S. Cl. 24/68 E; 24/68 R

(57) ABSTRACT

A securing arrangement for a diving cylinder, and more particularly for use in securing a diving cylinder to a harness of a buoyancy control device, includes: a securing strap for securing the cylinder to the harness; a strap-retaining device allowing the strap to pass therethrough in one direction, and selectively preventing the strap from passing therethrough in an opposite direction; and a pivotable tensioning lever for increasing the tension of the securing strap.

### FIELD OF THE INVENTION

This invention relates to a securing arrangement for a diving cylinder, and more particularly to a securing arrangement for use in securing a diving cylinder to a harness of a buoyancy control device.

### BACKGROUND TO THE INVENTION

A buoyancy control device (BCD), also known as a buoyancy compensator (BC), is a piece of diving equipment worn by a diver that assists the diver to regulate and control his or her overall buoyancy relative to the water. A buoyancy control device typically includes a harness component that is worn by the diver, and to which a diving cylinder(s) are secured.

In known prior art configurations the cylinder is generally secured to a back plate of the harness by means of a webbing strap and buckle configuration. Since substantial tension is required to prevent the cylinder from becoming detached during a dive, manufacturers generally use nylon webbing and buckles incorporating cams to obtain the required tightening force. A cam-type buckle typically includes a cam that pushes down onto the webbing that is passed through the buckle, and prevents the webbing from slipping back through the buckle. Tensioning is achieved by exerting a direct pulling force on the webbing.

However, it has been found in practice that it is often difficult and time consuming to thread the webbing through most of the available cam buckles. Cam buckles that are of simpler configuration, where threading of the webbing may be somewhat easier, in turn requires substantially more effort to be adjusted for different cylinder diameters. In both cases, i.e. the simple or more complicated cam buckles, significant effort is required to achieve sufficient tension in the webbing strap to ensure proper engagement of the cylinder. Also, changing between cylinders of different diameters is difficult and time-consuming.

An additional shortcoming inherent to nylon webbing is that the webbing tends to stretch to some extent when it becomes permeated with water, which can easily result in the cylinder loosening during a dive if not pre-soaked in water.

### OBJECT OF THE INVENTION

It is accordingly an object of the invention to provide a securing arrangement for use in securing a diving cylinder to a harness of a buoyancy control device, which will at least partially alleviate the above disadvantages.

It is also an object of the invention to provide a securing arrangement for use in securing a diving cylinder to a harness of a buoyancy control device that will be a useful alternative to existing securing arrangements.

### SUMMARY OF THE INVENTION

According to the invention there is provided a securing arrangement for use in securing a diving cylinder to a harness of a buoyancy control device, the arrangement including:
a securing strap for securing the cylinder to the harness;
a strap-retaining device allowing the strap to pass therethrough in one direction, and selectively preventing the strap from passing therethrough in an opposite direction; and
a pivotable tensioning lever for increasing the tension of the securing strap.

Preferably the securing strap comprises a plurality of separate strap sections.

The strap may comprise a plurality of apertures in a surface thereof. Preferably, at least one of the strap sections may include a plurality of apertures provided in a surface thereof.

Preferably the strap-retaining device is adapted releasably to engage the apertures provided in the securing strap. The strap-retaining device may be in the form of a strap-retaining lever having an end that engages the apertures provided in the securing strap.

The strap-retaining lever may be displaceable between a retaining position wherein an end of the lever engages an aperture provided in the securing strap, and a release position wherein the end is spaced apart form the aperture so as to allow the securing strap to be freely displaceable.

There is also provided for the tensioning lever to engage the apertures provided in the securing strap in order to exert a force on the securing strap when actuated. Preferably the force is exerted on the securing strap by inducing movement when the lever is pivoted.

Alternatively, the tensioning lever may be in the form of an over centred buckle mechanism located between two adjacent strap sections, the tensioning lever exerting a tensile force on the securing strap when displaced from an open to a closed position.

The securing strap may have an at least partially serrated zone. Troughs formed between adjacent serrations may define the apertures in the securing strap.

In a preferred embodiment the strap-retaining device may be in the form of a mechanical ratchet buckle.

In another embodiment the securing arrangement may include an over centre buckle.

According to a further aspect of the invention there is provided the use of a mechanical ratchet buckle to secure a diving cylinder to a buoyancy control device.

According to a still further aspect of the invention there is provided the use of an over centred buckle to secure a diving cylinder to a buoyancy control device.

### BRIEF DESCRIPTION OF THE DRAWINGS

Preferred embodiments of the invention are described by way of non-limiting examples, and with a reference to the accompanying figures in which:

FIG. 1 is a perspective view of the securing arrangement in accordance with a first embodiment of the invention, the securing arrangement being attached to a harness of a buoyancy control device;

FIG. 2 is a side view of the securing arrangement of FIG. 1, with the strap-retaining device in a retaining position;

FIG. 3 shows the securing arrangement of FIG. 2 with the tensioning lever being actuated;

FIG. 4 shows the securing arrangement of FIGS. 2 and 3, with the retaining lever displaced to a released position;

FIG. 5 is a plan view of a further securing arrangement in accordance with the invention;

FIG. 6 is a plan view of a still further securing arrangement in accordance with the invention; and

FIG. 7 is a perspective view of the securing arrangement of FIG. 5.

### DETAILED DESCRIPTION OF THE INVENTION

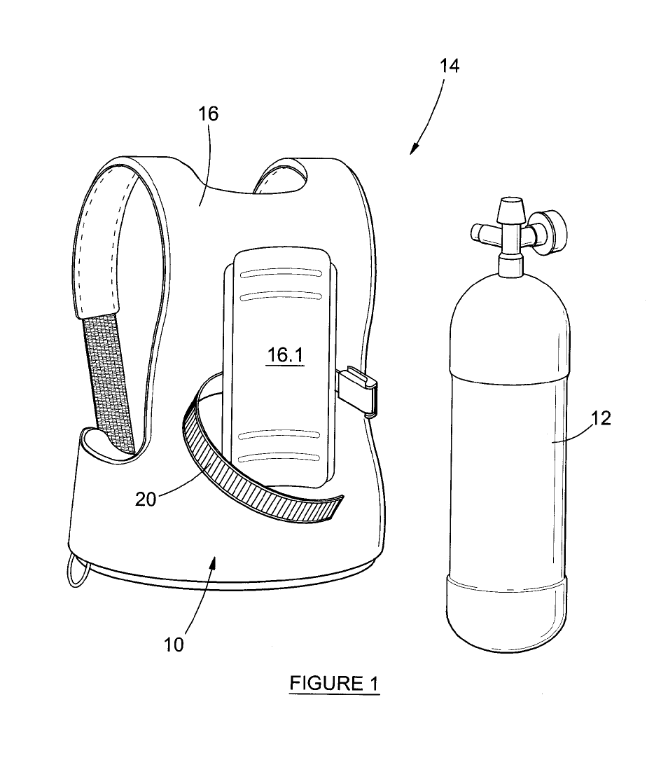

Referring to the drawings, in which like numerals indicate like features, a securing arrangement in accordance with the invention is generally indicated by reference numeral 10. As is best seen in FIG. 1, a securing arrangement 10 is typically connected to a harness 16 of a buoyancy control device 14. More particularly, the securing arrangement 10 is connected to a back plate of the harness 16. The securing arrangement 10 is provided in order to secure a diving cylinder 12 to the buoyancy control device 14. This invention is directed to the particular configuration of the securing arrangement 10 for use in securing a diving cylinder 12 to the buoyancy control device 14.

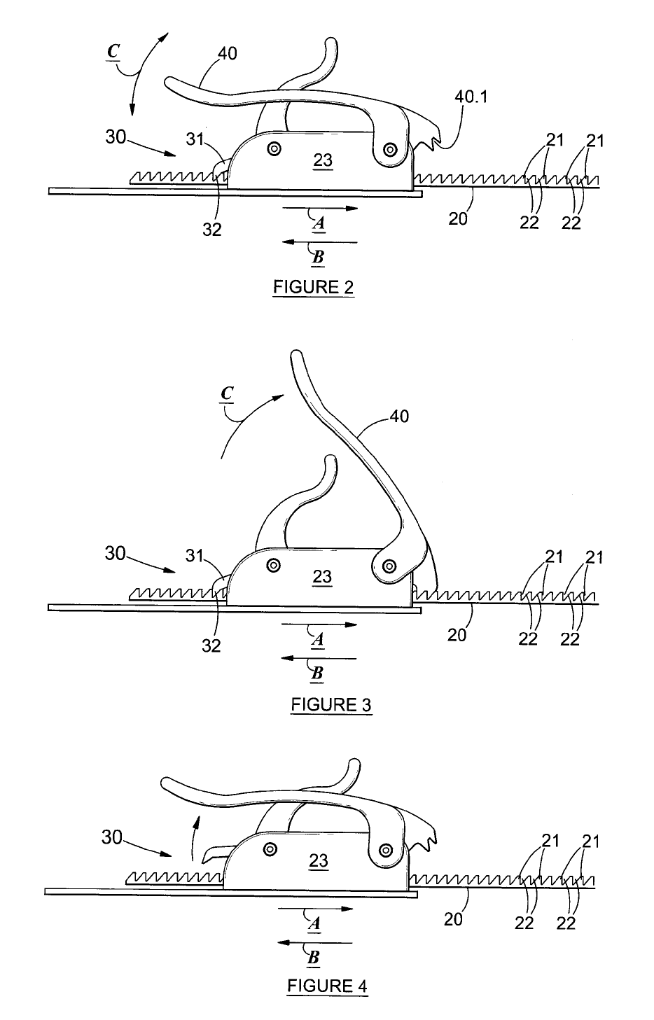

A first embodiment of the securing arrangement in accordance with the invention is shown in FIGS. 1-4, and includes a securing strap 20 being secured to the back plate 16.1 of the harness 16, with two opposing ends of the securing strap being located adjacent one another. One end of the securing strap is connected to a mechanical ratchet buckle 23, the working of which is described in more detail herein below. The second end of the securing strap 20 can subsequently be fed into the mechanical ratchet buckle 23 in order to secure and tension the strap so as to securely hold the diving cylinder 12. The mechanical ratchet buckle 23 includes a strap retaining device 30 as well as a tensioning lever 40. The securing strap 20 includes serrations or teeth in an upper surface thereof and apertures 22 are defined by the troughs between adjacent teeth. In this embodiment the strap retaining device 30 includes a retaining lever 31, an end 32 of which engages the apertures 22 so as to prevent movement in the direction of arrow A of the securing strap 20 relative to the mechanical ratchet buckle 23. The lever 31 can selectively be displaced to a disengaged position, as shown in FIG. 4, in which position the securing strap 20 is allowed to be displaced in the direction of arrow A, so as to enable removal of the diving cylinder 12.

The mechanical ratchet buckle 23 also includes a tensioning lever 40 which can be actuated in a pivotable manner so as to tension the securing strap 20 that extends through the mechanical ratchet bucket 23. In this particular embodiment, the tensioning lever of this embodiment terminates in a tooth formation 40.1 that is dimensioned and configured to engage the complementary shaped troughs or apertures 22 formed between adjacent teeth or serrations of the securing strap 20. When the tensioning lever is pivoted to and fro as is indicated by arrow C, the securing strap is displaced in direction of arrow B. The strap retaining device 30 and in particular the end 32 that engages the apertures 32, prevents the securing strap 20 from being displaced in the direction indicated by arrow A when the end 40.1 of the tension lever 40 disengages the apertures 22, thus allowing the securing strap 20 to be sequentially tensioned. In the particular embodiment, the strap retaining device 30 and the tension lever 40 form part of a unitary mechanical ratchet buckle 23, but it is appreciated that the functionality may also be achieved by utilizing two separate elements as described in more detail below.

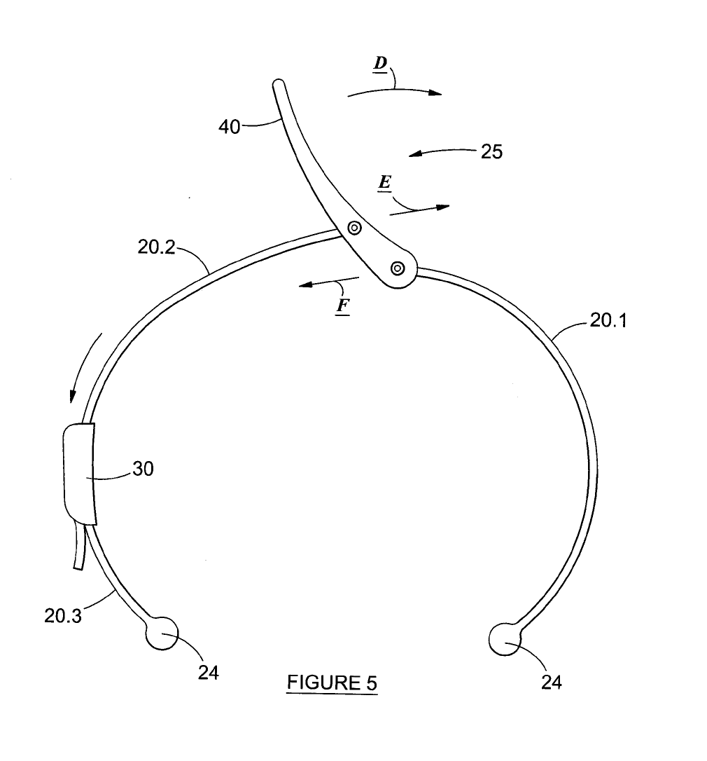

A further embodiment of the invention is shown in FIG. 5. In this embodiment the securing strap 20 comprises three securing strap sections, 20.1, 20.2 and 20.3. The ends of the securing strap section 20.1 and 20.3 are secured to the back plate 16.1 of the harness 16. In this embodiment the strap-retaining device 30 is similar to that utilized in the embodiment described above, but in this case the strap retaining device 30 does not include an integral tensioning lever. The strap retaining device 30 is used for preliminary tensioning of the securing strap 20 and more particularly the strap sections 20.1, 20.2 and 20.3, but final tensioning is achieved by utilizing an independent tensioning device in the form of an over centre buckle 25. The over centre buckle includes a tensioning lever 40 to which there is pivotally secured an end of first strap section 20.1 and also an end of the second strap section 20.2. When the lever 40 is actuated, so as to be displaced in the direction of arrow D, the securing strap 20 is tensioned due to the movement of securing strap section 20.1 in direction F and securing strap section 20.2 in direction E, thus resulting in the two strap sections being pulled towards one another so as to increase the tension in the strap 20 in totality.

An additional compensating device may be provided to allow for efficient tensioning of the securing arrangement, which may be, inter alia, in the form of a compensation pad located inside an inner face of securing strap section 20.1, a pneumatic pad located inside an inner surface of the securing strap 20.1, an elastic section provided in the securing strap 20, or alternatively, one or more of the securing strap sections 20.1, 20.2, 20.3 being elastic. There is also provided for the over centre buckle 25 to include a slot formation allowing the end of securing strap section 20.2 to slide therein.

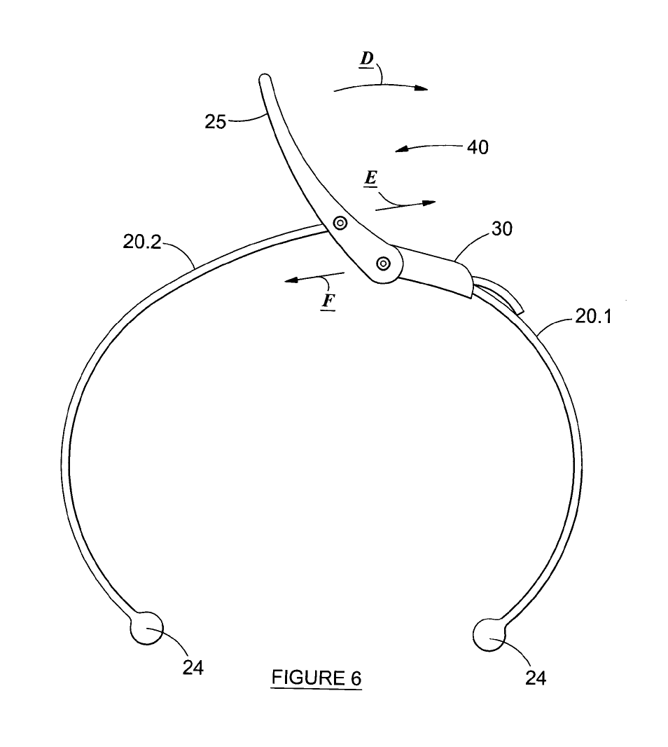

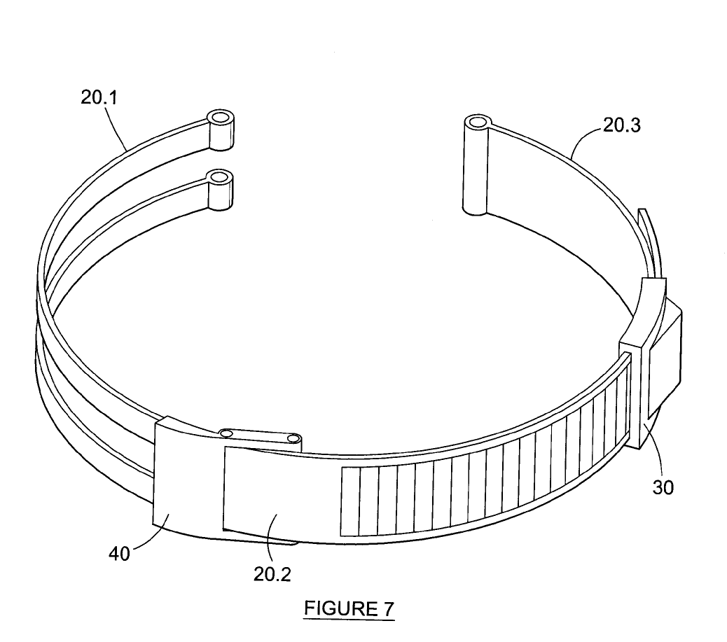

A still further embodiment of the invention is shown in FIG. 6, and is similar to the embodiment shown in FIG. 5, save for the strap retaining device 30 being located adjacent the tensioning lever 40 in the form of the over centre buckle 25. This arrangement will function in the same way, but in this embodiment only two strap sections 20.1 and 20.2 are required.

It is a common denominator of all the embodiments of this invention that the securing arrangement 10 includes a strap retaining device 30 that allows displacement of the securing strap 20 in a first direction, but not in a second opposite direction, and some tensioning lever arrangement that can be actuated in order to increase the tension in the securing strap. The inventor foresees that it will be easier to secure a diving cylinder to a harness of a buoyancy control device, and the cylinder will also be more secure than cylinders secured with traditional securing means. Also, by using the serrated or toothed securing strap, one can do away with the use of traditional nylon webbing, and the problems associated with pre-soaking of the webbing can also be circumvented.

It will be appreciated that the above are only some embodiments of the invention, and that there may be many variations in detail without departing from the spirit and/or the scope of the invention.

1. A securing arrangement, for use in securing a diving cylinder to a harness of a buoyancy control device, the arrangement including:
a. a securing strap for securing the cylinder to the harness;
b. a strap-retaining device allowing the strap to pass there through in one direction, and selectively preventing the strap from passing there through in an opposite direction; and
c. a pivotable tensioning lever for increasing the tension of the securing strap.

2. The securing arrangement of claim 1, wherein the securing strap includes a plurality of separate strap sections.

3. The securing arrangement of claim 2, wherein at least one strap section includes a plurality of apertures in a surface thereof.

4. The securing arrangement of claim 1, wherein the strap-retaining device releasably engages apertures included in a surface of the securing strap, the apertures being located in at least one section of the securing strap.

5. The securing arrangement of claim 4, wherein the strap-retaining device is in the form of a strap-retaining lever having an end that engages the apertures provided in the securing strap.

6. The securing arrangement of claim 1, wherein the strap-retaining device is in the form of a ratchet buckle.

7. The securing arrangement of claim 3, wherein the tensioning lever engages the apertures in the securing strap in order to exert a force on the securing strap when actuated.

8. The securing arrangement of claim 2, wherein the tensioning lever is in the form of an over centred buckle mechanism between two adjacent strap sections.

9. (canceled)

10. (canceled)

11. The securing arrangement of claim 3, wherein the tensioning lever is in the form of an over centred buckle mechanism between two adjacent strap sections.
